(19) United States
(12) Patent Application Publication
(10) Pub. No.: US 2018/0019079 A1
(43) Pub. Date: Jan. 18, 2018

(54) PUSH SWITCH

(71) Applicant: PANASONIC INTELLECTUAL PROPERTY MANAGEMENT CO., LTD., Osaka (JP)

(72) Inventor: KATSUICHI MINAMI, Fukui (JP)

(21) Appl. No.: 15/545,718

(22) PCT Filed: Feb. 5, 2016
(86) PCT No.: PCT/JP2016/000596

§ 371 Date: Jul. 23, 2017

(30) Foreign Application Priority Data
Feb. 20, 2015 (JP) 2015-031274

(51) Int. Cl. H01H 13/56; H01H 13/04; H01H 13/14

(52) U.S. Cl. CPC H01H 13/56; H01H 13/14; H01H 13/04; H01H 2235/01

(57) ABSTRACT

A push switch of a push-operating type includes a locking mechanism, has a thin and small size with a simple structure ensuring a reliable operation and allowing a coil spring to be easily installed. A release-holding part with which a second end, serving as another end of a stopper, is engaged to hold an operating body at a released position is provided in a cam groove located at a rear portion of a locking cam portion to provide a gap with a predetermined interval between the operating body and a restriction part of the case in forward and rearward directions, when the operating body is located at the released position. Thus, a space in an accommodation part is expanded in the forward and rearward directions when the push switch is manufactured, the coil spring is prevented from being disengage from the accommodation part, and therefore, is installed stably. Therefore, a thin and small sized push switch in which operation thereof is ensured and a coil spring is easily installed can be provided.

### TECHNICAL FIELD

The present invention relates to a push switch that has a locking mechanism for locking an operating body at a predetermined moving position while performing electrical contact and separation of switch contacts by pressing the operating body.

### BACKGROUND ART

In recent years, a thin and small sized switch whose operation is ensured has been required even in a push switch of push-operating type having a locking mechanism used for electronic devices, such as a cellular phone unit and a tablet terminal, as such devices are slimmed down and miniaturized.

A push switch with a locking mechanism is disclosed in PTL 1.

Such a push switch includes a case in which an operating member is accommodated to be movable in a predetermined direction, and a coil spring that is disposed between the operating member and the case and urges the operating member in the predetermined direction. Inside the case, a cam part having a heart shaped cam groove is provided. One end of a pin shaped stopper is supported by the operating member, and the other end of the stopper is in contact with the cam part. The stopper is urged toward the cam part side by a presser bar spring, which is separated from the stopper.

A movable contact is provided on a side surface of the operating member in a direction perpendicular to a moving direction of the operating member. A fixed contact is provided on a side surface of a switch case facing the movable contact. As the operating member moves, the movable contact and the fixed contact are brought in contact and released, and the stopper is engaged with the cam part and fixed. Thus, the operating member is configured to be lock and unlocked.

### CITATION LIST

### Patent Literature

PTL 1: Japanese Patent Laid-Open Publication No. 10-340649

### SUMMARY

A push switch includes a case, an operating body, a coil spring, a stopper, and a switch contactor. The case has an upper surface having an opening provided therein. The operating body is accommodated in the case to be movable reciprocatably in a forward direction and a rearward direction along the upper surface of the case. The operating body includes a lock cam part formed on an upper surface of a rear portion of the operating body, the lock cam part including a cam part and a cam groove provided around the cam part, and an operating part formed at a front portion of the operating body. The coil spring is accommodated in an accommodation part between the case and a rear end of the operating body. The coil spring urges the operating body in the forward direction. The stopper has one end engaged with the case to be fixed and another end contacting the lock cam part. The switch contactor contacts and is released as the operating body moves. The push switch is maintained in either a locked state in which the another end of the stopper is engaged with the lock cam part to hold the operating body at a locked position by pressing the operating part in the rearward direction, or in a released state in which the operating part most forwardly projects from the case to hold the operating body at a released position. A release-holding part with which the end of the stopper is engaged so as to hold the operating body at the released position is provided in the cam groove located in a rear portion of the lock cam part. A restriction part for restricting the operating body to move in the forward direction is provide in a front portion of the case to provide a gap with a predetermined interval between the operating body and the restriction part in the forward direction and the rearward direction when the operating body is located at the released position.

The release-holding part with which the second end of the stopper is engaged to hold the operating body at the released position is provided in the cam groove located in the rear portion of the lock cam part to provide the gap with a predetermined interval between the operating body and the restriction part in the forward and rearward direction when the operating body is at the released position. Thus, the operating body moves more forward than the released position by the gap with the predetermined interval when the push switch is manufactured, and a space in the accommodation part between a rear end of the operating body and the case is expanded in the forward direction, so that the coil spring is prevented from being disengaged from the accommodation part when the coil spring is installed in the accommodation part, thereby installing the coil spring stably. This configuration provides a thin and small sized push switch in which operation thereof is ensured and a coil spring is easily installed.

### BRIEF DESCRIPTION OF DRAWINGS

FIG. 1 is a plan view of a push switch in accordance with an exemplary embodiment having a cover removed.

FIG. 2 is an exploded perspective view of the push switch in accordance with the embodiment.

FIG. 3A is a plan view of the push switch in accordance with the embodiment for illustrating a method of manufacturing the push switch.

FIG. 3B is a plan view of the push switch in accordance with the embodiment for illustrating the method of manufacturing the push switch.

FIG. 3C is a plan view of the push switch in accordance with the embodiment for illustrating the method of manufacturing the push switch.

FIG. 4A is a front view of the push switch in accordance with the embodiment for illustrating the method of manufacturing the push switch.

FIG. 4B is a front view of the push switch in accordance with the embodiment for illustrating the method of manufacturing the push switch.

FIG. 4C is a front view of the push switch in accordance with the embodiment for illustrating the method of manufacturing the push switch.

FIG. 5A is a plan view of the push switch in accordance with the embodiment for illustrating an operation of the push switch.

FIG. 5B is a plan view of the push switch in accordance with the embodiment for illustrating an operation of the push switch.

### DETAIL DESCRIPTION OF PREFERRED EMBODIMENT

A problem of the conventional push switch will be briefly described below. In order to provide the conventional push switch with a thin and small size, it may be necessary to reduce an external diameter of a coil spring which urges an operating member in a predetermined direction, and increase a length of the coil spring to accommodate the coil spring in a smaller space of a spring accommodation part.

In the case where such a coil spring is installed between the operating member and a case, upon being accommodated in the spring accommodation part, the coil spring is easily disengaged from the spring accommodation part due to a compressive force of the spring because its external diameter is small and its length is large. This configuration prevents the coil spring from being installed, hence preventing automated manufacturing.

To solve such a conventional problem, a thin and small sized push switch in which operation thereof is ensured and a coil spring is easily installed.

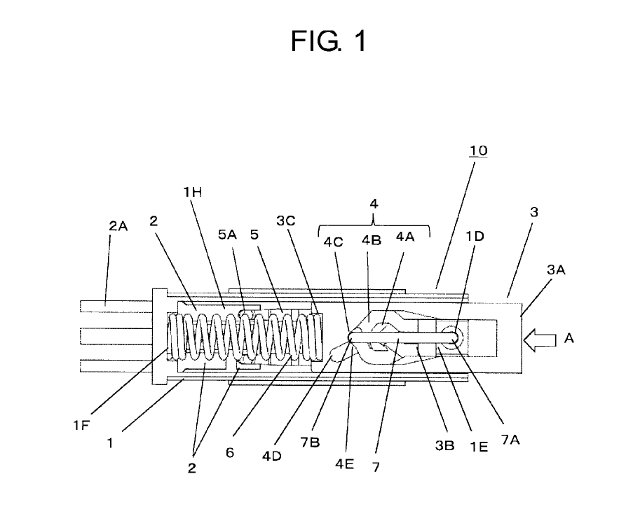

Hereinafter, an embodiment of the present invention will be described with reference to FIGS. 1 to 5B.

### Exemplary Embodiment

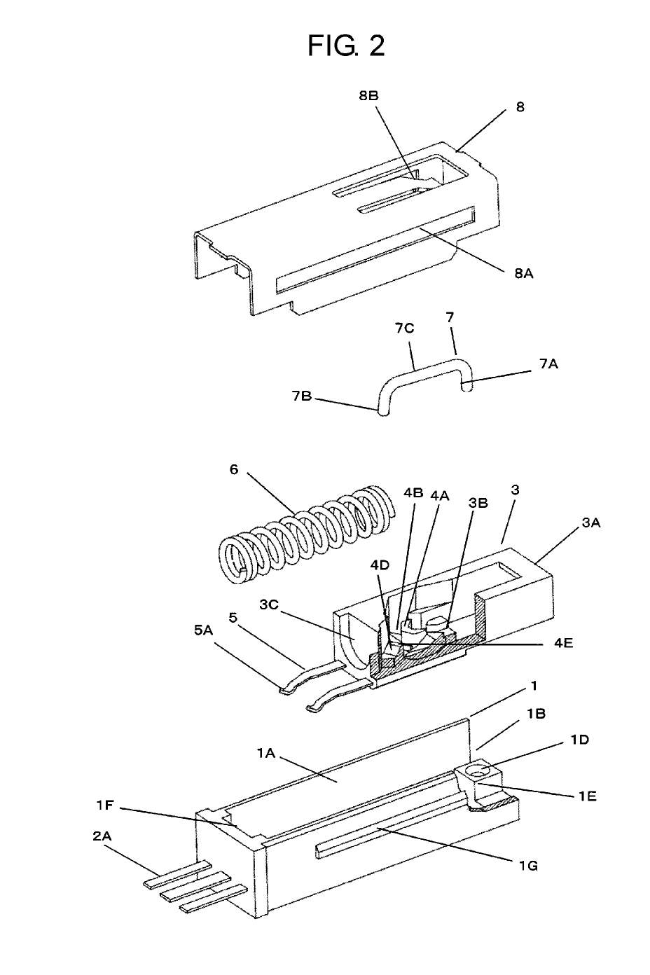

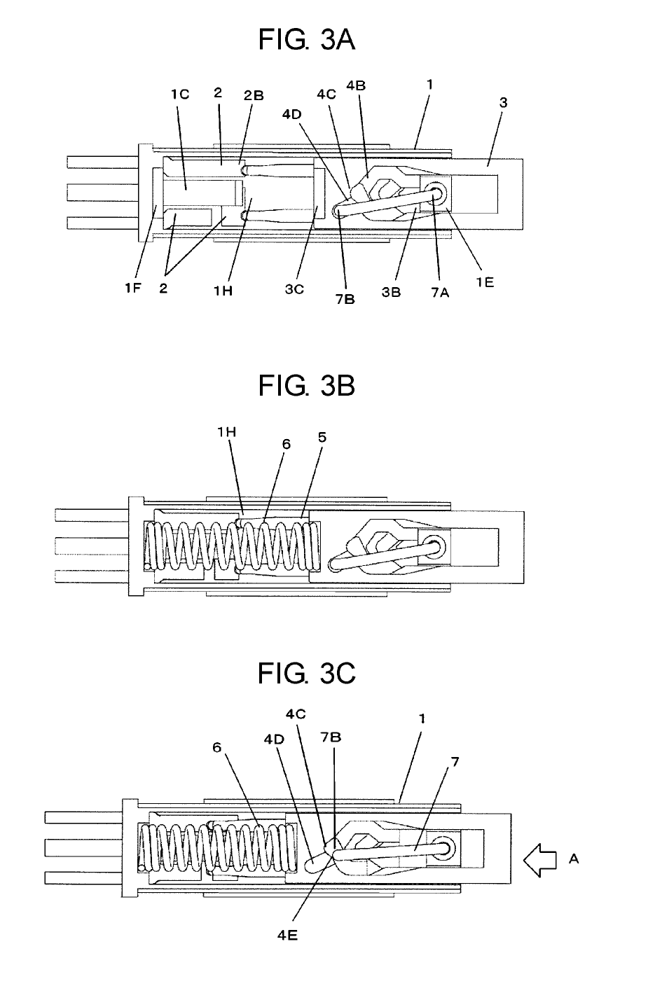

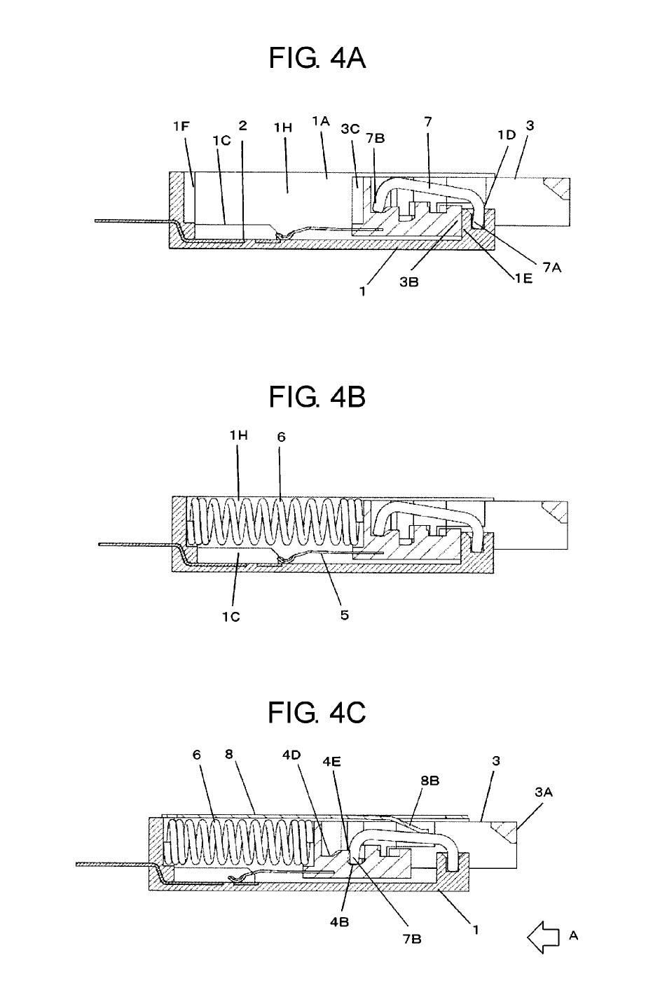

FIG. 1 is a plan view of a push switch in accordance with an exemplary embodiment having a cover removed. FIG. 2 is an exploded perspective view of the push switch. FIGS. 3A to 3C are plan views of the switch for illustrating a method of manufacturing the switch. FIGS. 4A to 4C are front views of the switch for illustrating the method of manufacturing the switch.

FIG. 1 is a plan view of push switch 10 in a released state in which an operating body is most forwardly projecting in a normal use state. The structure of case 1 will be described below. Case 1 is made of insulating resin, such as a liquid crystal polymer or poly butylene terephthalate (hereinafter, referred to as PBT). As shown in FIGS. 1 and 2, case 1 has substantially an elongated box shape having an upper surface and a side surface which is located in a longitudinal direction. The upper surface of the case has opening 1A provided therein. The side surface of the case has opening 1B provided therein. The side surface having opening 1B therein is defined in a forward direction, and a front and rear of other parts are determined depending on the state where they are incorporated in case 1.

As shown in FIGS. 3A and 4A, spring restriction part 1C is formed on a bottom surface of a rear portion of case 1 substantially at a center of case 1 in a width direction perpendicular to the forward direction and a rearward direction, and extends forward by a predetermined length while projecting upward by a predetermined height. Restriction part 1E having substantially a rectangular parallelepiped shape is provided in the vicinity of opening 1B provided in a front surface of case 1. Restriction part 1E projects upwardly, and has locking hole 1D therein.

Case 1 includes spring holding part 1F, accommodation part 1H, and engagement part 1G. These parts will be described later.

The structure of fixed contact 2 will be described below. Plural fixed contacts 2 are disposed on the bottom surface of case 1 and located inside the rear portion of case 1. Fixed contacts 2 are exposed from the bottom surface and formed by insert molding. Each fixed contact 2 includes terminal part 2A extending outwardly. Fixed contact 2 is made of a conductive metal plate, such as a phosphor-bronze plate, a beryllium copper plate, or a brass plate. The fixed contacts 2 are disposed on the bottom surface so as to sandwich spring restriction part 1C between fixed contacts 2.

The structure of operating body 3 will be described below. Operating body 3 is made of insulating resin, such as liquid crystal polymer or PBT. Operating body 3 has a shape slenderly extending in the forward and rearward directions. Operating part 3A is provided in a front portion of operating body 3. Operating part 3A has an upper surface partially opening and a lower surface fully opening. An upper surface of a rear portion of operating body 3 opens.

Operating body 3 includes operating part 3A, contact part 3B, and operating body spring holding part 3C, which will be described later.

The rear portion of operating body 3 in the width direction is guided along both inner sides of case 1 corresponding thereto. Outer side surfaces of operating part 3A located in the front portion of operating body 3 in the width direction are guided along both inner side surfaces of case 1. Operating body 3 is accommodated in case 1 to be movable in the forward and rearward directions. In the front portion of operating body 3, inner side surfaces of operating part 3A may be guided by outer side surfaces of restriction part 1E of case 1 in the width direction.

The structure of lock cam part 4 will be described below. Lock cam part 4 includes cam part 4A, cam groove 4B, release-holding part 4C, stopper guide 4D, and step part 4E. Cam part 4A is provided on the bottom surface of the rear portion of operating body 3. Cam part 4A has substantially s heart shape and projects upwardly. Cam groove 4B is provided in the bottom surface of the rear portion of operating body 3. Plural steps are provided at predetermined positions around cam groove 4B.

Release-holding part 4C that is slightly recessed rearward to have substantially an arcuate shape is formed in the substantially middle of the rear portion of cam groove 4B in the width direction. Stopper guide 4D with substantially s groove shape extends in the rearward direction from cam groove 4B near release-holding part 4C. Stopper guide 4D is tilted oblique with respect to a center axis of operating body 3 in the width direction. Step part 4E is provided in a boundary between stopper guide 4D and cam groove 4B. Stopper guide 4D has step part 4E which is higher than a surface of cam groove 4B. Step part 4E partitions stopper guide 4D from cam groove 4B.

A rear end of stopper guide 4D may be closed with a wall of operating part 3A as shown in FIG. 1, or may open by penetrating in the width direction or a rear end surface of operating body 3.

Contact part 3B is formed in a front of lock cam part 4. Contact part 3B has substantially s planar shape and faces restriction part 1E of case 1. Contact part 3B is located apart from a rear surface of restriction part 1E of case 1 with a gap with a predetermined interval between contact part 3B and the rear surface of restriction part 1E. Operating body spring holding part 3C is provided on the rear end surface of the operating body 3. Holding part 3C is recessed in the forward direction. A lower part of holding part 3C has substantially a semicircular shape while an upper part of holding part 3C is parallel to the width direction.

The structure of movable contacts 5 will be described below. Movable contacts 5 extend rearward from the rear end of operating body 3 to the outside. Movable contacts 5 are connected inside operating body 3 and formed in operating body 3 by, e.g. insert molding. Movable contact 5 is made of a highly elastic conductive metal plate, such as a beryllium copper plate or a phosphor-bronze plate. Contact point part 5A projecting downwardly is formed at a tip end of movable contact 5.

Contact point part 5A of each of movable contacts 5 press and contact fixed contact 2 located below movable contact 5 while slightly bending upwardly. Contact point part 5A and corresponding fixed contact 2 are contact and are released as operating body 3 moves in the forward and rearward directions. Movable contacts 5 and fixed contact 2 constitute a switch contactor.

Movable contact 5 extends from the rear end of operating body 3. The height of movable contact 5 from the bottom surface of case 1 is lower than a height of spring restriction part 1C.

The structure of stopper 7 will be described below. Stopper 7 includes first end 7A, second end 7B, and connection part 7C. Stopper 7 is made of, e.g. a metal wire, such as a stainless steel wire or a piano wire, having substantially a U-shape. First end 7A, one end of stopper 7, is engaged with and fixed to locking hole 1D of restriction part 1E of case 1. Second end 7B, another end of stopper 7, contacts release-holding part 4C located in a rear portion of cam groove 4B.

Coil spring 6 is made of a metal wire, such as a stainless steel wire or a piano wire, and is spirally wound to have an elongated shape. Coil spring 6 is accommodated in accommodation part 1H between operating body spring holding part 3C and spring holding part 1F while being slightly compressed. Operating body spring holding part 3C is located in the rear portion of operating body 3. Spring holding part 1F is provided inside the rear portion of case 1 to be recessed rearward and faces operating body spring holding part 3C. Coil spring 6 is restricted to deform downward with spring restriction part 1C located on the bottom surface of case 1. Coil spring 6 urges operating body 3 in the forward direction.

Coil spring 6 is disposed behind operating body 3. The switch contactor is constituted by movable contact 5 extending from the rear end of operating body 3 and fixed contact 2 located on the bottom surface of case 1. The switch contactor is provided on the bottom surface of case 1 below coil spring 6 in parallel with coil spring 6, thereby reducing a length of the entire push switch in the forward and rearward directions, and reducing a width of its shape in a thickness or width direction.

Coil spring 6 is restricted with spring restriction part 1C to deform in a direction toward the switch contactor and perpendicular to a longitudinal direction of coil spring 6, thereby reliably contacting and releasing the switch contactor without receiving interference of coil spring 6 on the switch contactor even when coil spring 6 is installed in case 1 or deformed by the operation of operating body 3.

First end 7A of stopper 7 is engaged with and fixed to locking hole 1D of case 1 while second end 7B contacts release-holding part 4C of operating body 3. When operating body 3 is urged forward by coil spring 6, this configuration maintains the push switch in a released state in which operating part 3A of operating body 3 is held at a released position, i.e., most forwardly projects from the front surface of case 1.

The structure of cover 8 will be described below. Cover 8 is made of, e.g. a highly elastic metal plate, such as a stainless steel plate, a beryllium copper plate, or a phosphor-bronze plate. A portion of an upper surface of a front portion of cover 8 around pressing part 8 is cut off. Thus, pressing part 8 is integrally formed to extend forward while bending and tilting downward. Cover 8 has engagement holes 8A provided therein.

Cover 8 having a cross section having substantially a U-shape is disposed above opening 1A located in the upper surface of case 1. Engagement holes 8A provided in both side surfaces of cover 8 in the width direction is engaged with engagement part 1G provided on the both outer side surfaces of case 1, thus attaching cover 8 to case 1. A tip end of pressing part 8B contacts connection part 7C between first end 7A and second end 7B of stopper 7 while slightly bending and pressing connection part 7C with a bending force, thereby securely engaging first end 7A of stopper 7 with locking hole 1D and fixing first end 7A of stopper 7 to locking hole 1D. The tip end of pressing part 8B urges connection part 7C to cause second end 7B to contact a surface of lock cam part 4 securely.

Pressing part 8B is integrally formed with cover 8 and urges stopper 7 downward. This configuration does not require another member, such as a flat spring, for pressing the stopper in a lower surface of cover 8, thereby reducing the number of components and slim down.

Operating body 3 thus urged by coil spring 6 and stopper 7 having one end engaged with and fixed to case 1 and another end contacting lock cam part 4 of operating body 3 are accommodated in case 1. Cover 8 covers opening 1A provided in the upper surface of case 1, thereby providing push switch 10.

A method of manufacturing push switch 10 with the above structures will be described below with reference to FIGS. 3A to 3C and 4A to 4C.

First, as shown in FIGS. 3A and 4A, operating body 3 is inserted into case 1 through opening 1A to cause contact part 3B to contact a rear surface of restriction part 1E of case 1.

The length of accommodation part 1H between spring holding part 1F of case 1 and operating body spring holding part 3C of operating body 3 in the forward and rearward directions is larger than a length of accommodation part 1H when operating body 3 is located at a released position, which most widely expands.

Next, first end 7A of stopper 7 is inserted into locking hole 1D, and second end 7B is placed on an upper surface of stopper guide 4D behind lock cam part 4, thus disposing the stopper 7 in operating body 3.

Stopper guide 4D is tilted oblique with respect to the center axis of operating body 3 in the width direction and extends rearward from cam groove 4B near release-holding part 4C, so that stopper 7 is also oblique with respect to the center axis of operating body 3. Accordingly, for example, if a thickness of a wall between second end 7B and operating body spring holding part 3C is constant, a length of operating body 3 in the forward and rearward directions can be shortened by an amount of the tilting of stopper guide 4D than the case where stopper 7 is disposed such that stopper guide 4D extends in parallel with the center axis of operating body 3, thereby reducing the entire length of push switch 10 in the forward and rearward directions.

As shown in FIGS. 3B and 4B, coil spring 6 is inserted into accommodation part 1H while being slightly compressed. At this moment, accommodation part 1H is more expanded by a gap with a predetermined interval than the length of accommodation part 1H when the push switch is in the released state. This configuration reduces an amount of deflection of coil spring 6, so that coil spring 6 is compressed with a small force. Therefore, coil spring 6 is easily inserted into accommodation part 1H and installed stably without disengaging from accommodation part 1H when inserted.

When coil spring 6 is installed, even if the vicinity of the middle portion of coil spring 6 in the longitudinal direction slightly deforms downward, the deformation is restricted by the upper surface of spring restriction part 1C located in the substantially middle of case 1. This configuration prevents the outer circumference of coil spring 6 from contacting movable contact 5. Thus, movable contact 5 receives no interference from coil spring 6.

Next, in the state of FIGS. 3B and 4B, the upper surface of case 1 is covered with cover 8, and engagement part 1G is engaged with engagement hole 8A. At this moment, pressing part 8B contacts stopper 7 so as to press stopper 7 with the bending force. Cover 8 is thus attached to case 1.

As shown in FIGS. 3C and 4C, when operating part 3A is operated to be pressed rearward, i.e., in a direction indicated by arrow A against the urging force of coil spring 6 from the state shown in FIGS. 3B and 4B in which second end 7B of stopper 7 contacts the upper surface of stopper guide 4D, second end 7B securely moves forward on the grooved stopper guide 4D stably with respect to operating body 3, and then, moves over step part 4E. After that, second end 7B moves down and contacts cam groove 4B.

Subsequently, when pressing operating body 3 is stopped, operating body 3 is urged forward and moved. According to this movement, second end 7B contacts release-holding part 4C located in the rear portion of cam groove 4B and stops on release-holding part 4C. As shown in FIG. 1, operating body 3 is held at the released position at which operating part 3A most projects from opening 1B of case 1 in a normal use state to maintain push switch 10 in the released state, thus manufacturing push switch 10.

Push switch 10 has a thin and small shape having a diameter ranging from 2 mm to 3 mm and has a length excluding terminal part 2A of about 10 mm.

After push switch 10 is completed, second end 7B of stopper 7 slides in cam groove 4B even if operating body 3 is pressed to move in the forward and rearward directions. However, second end 7B does not return back to stopper guide 4D since step part 4E partitions stopper guide 4D form cam groove 4B.

Push switch 10 having the above configuration is installed to electronic devices, such as a cellular phone unit and a tablet terminal, or an elongated switch accommodation part, such as a pen type input device in while terminal part 2A is connected to a terminal area located inside the device and operating part 3A is directed to the outside.

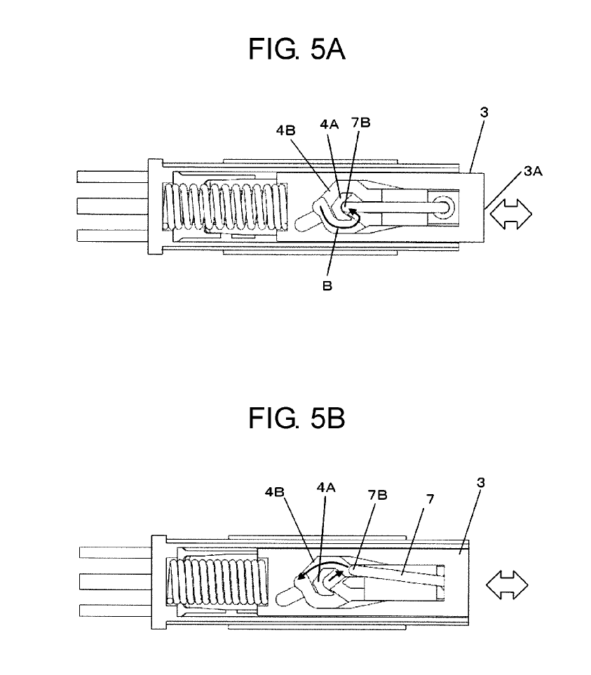

An operation of push switch 10 as mentioned above will be described below with reference to FIGS. 1 to 5B, a plan view. FIG. 5B is a plan view of the switch having the cover removed. The released state shown in FIG. 1 is a first connection state in which second end 7B of stopper 7 contacts release-holding part 4C located in the rear portion of cam groove 4B, operating body 3 most forwardly projects and is held, and contact point part 5A of each of movable contacts 5 contacts a corresponding one of contact point parts 2B of fixed contacts 2 so as to press contact point part 5A with the bending force.

Next, after operating part 3A is operated to be pressed rearward, i.e., in a direction indicated by arrow A from the released state in FIG. 1, when pressing operating part 3A is stopped, second end 7B slides in a direction indicated by arrow B along cam groove 4B located on the left-hand side viewing from front, as operating body 3 moves rearward as shown in FIG. 5A. In other words, operating body 3 moves forward through a full stroke position at which operating body 3 most backwardly moves in case 1. Thus, second end 7B contacts a center recessed portion of cam part 4A substantially with a heart shape and held at a locked position, thus changing to a locked state.

At this moment, contact point parts 5A contact corresponding contact point parts 2B of fixed contacts 2, which are different from the released state, so as to press them with the bending force, so that the state is changed to a second connection state.

Furthermore, when operating part 3A is operated to be pressed again in the locked state shown in FIG. 5A, second end 7B of stopper 7 is moved away from cam part 4A and guided in cam groove 4B located on the right-hand side as shown in FIG. 5B, and operating body 3 is moved forward, so that the state is returned back to the released state shown in FIG. 1.

Second end 7B of stopper 7 is thus held at the predetermined position while sliding in cam groove 4B in response to the pressing operation of operating body 3, and thus operating body 3 is moved from the released position to the full stroke position, and further to the locked position. In addition to this, the switch contactor is switched to the first connection state or the second connection state, and thus various functions of an electronic device or an input device are controlled.

As mentioned above, according to the embodiment, release-holding part 4C with which second end 7B, another end of stopper 7, is engaged so as to hold operating body 3 at the released position is provided in cam groove 4B located in the rear portion of lock cam part 4 to provide a gap with a predetermined interval between contact part 3B of operating body 3 and restriction part 1E of case 1 when operating body 3 is at the released position. When push switch 10 is manufactured, this configuration allows operating body 3 to be moved more forward than the released position by the gap with a predetermined interval, thereby expanding a space in accommodation part 1H between the rear end of operating body 3 and case 1 in the forward and rearward directions. This configuration prevents coil spring 6 from being disengaging from accommodation part 1H when coil spring 6 is installed in accommodation part 1H, thus allowing coil spring 6 to be installed stably. Accordingly, a thin and small sized push switch in which operation thereof is ensured and coil spring 6 is easily installed can be provided.

Grooved stopper guide 4D extending in the rearward direction and tilted oblique with respect to the center axis of operating body 3 in the width direction is formed in the vicinity of release-holding part 4C of lock cam part 4. Step part 4E is provided in a boundary between stopper guide 4D and cam groove 4B, such that stopper guide 4D has step part 4E higher than a surface of cam groove 4B, and step part 4E partitions stopper guide 4D from cam groove 4B. Thus, after being manufactured, when operating body 3 is operated to be pressed rearward, second end 7B of stopper 7 is guided forward in grooved stopper guide 4D, and securely moved stably. In a normal operation, second end 7B is locked or unlocked with step part 4E stably without returning back to stopper guide 4D. Stopper guide 4D extends while being tilted obliquely. Thus, if a thickness of a wall between second end 7B and operating body spring holding part 3C is constant, a length of operating body 3 in the forward and rearward directions can be more shortened by an amount of the tilting of stopper 7 than the case where stopper 7 is disposed such that stopper guide 4D extends in parallel with the center axis of operating body 3, thereby reducing the entire length of push switch 10 in the forward and rearward directions.

Opening 1A of case 1 is covered with cover 8 made of a highly elastic metal plate, and pressing part 8B contacts stopper 7 so as to press stopper 7 against lock cam part 4 with the bending force. Pressing part 8B is integrally formed with cover 8. This configuration does not require another member, such as a flat spring, in a lower surface of cover 8 for pressing the stopper, thereby reducing the number of components and slim down.

The structure that stopper 7 has substantially s U-shape, first end 7A of stopper 7 is engaged with and fixed to locking hole 1D of restriction part 1E of case 1, and second end 7B contacts cam groove 4B, but not limited to this. The stopper may have substantially a crank shape. The first end of the stopper may be engaged with and fixed to the cover located above the stopper. Even in the case, the present invention can be implemented although the manufacturing is difficult.

### INDUSTRIAL APPLICABILITY

A push switch in accordance with the present invention has a simple structure while allowing a coil spring to be installed, and has a thin and small size operating reliably, thus being useful as an operation switch for thin and small sized electronic devices or input devices.

### REFERENCE MARKS IN THE DRAWINGS

1 case
1A, 1B opening
1C spring restriction part
1D locking hole
1E restriction part
1F spring holding part
1G engagement part
1H accommodation part
2 fixed contact
2A terminal part
2B contact point part of fixed contact 2
3 operating body
3A operating part
3B contact part
3C operating body spring holding part
4 lock cam part
4A cam part
4B cam groove
4C release-holding part
4D stopper guide
4E step part
5 movable contact
5A contact point part of movable contact 5
6 coil spring
7 stopper
7A first end (one end)
7B second end (the other end)
7C connection part
8 cover
8B pressing part
10 push switch

1. A push switch comprising:
a case having an upper surface having an opening provided therein;
an operating body accommodated in the case to be movable reciprocatably in a forward direction and a rearward direction along the upper surface of the case, the operating body including
a lock cam part formed on an upper surface of a rear portion of the operating body, the lock cam part including a cam part and a cam groove provided around the cam part, and
an operating part formed at a front portion of the operating body;
a coil spring accommodated in an accommodation part between the case and a rear end of the operating body, the coil spring urging the operating body in the forward direction;
a stopper having one end engaged with the case to be fixed and another end contacting the lock cam part;
a switch contactor contacts and is released as the operating body moves; and
a restriction part provide in a front portion of the case, wherein
the push switch is maintained in either a locked state in which the another end of the stopper is engaged with the lock cam part to hold the operating body at a locked position by pressing the operating part in the rearward direction, or in a released state in which the operating part most forwardly projects from the case to hold the operating body at a released position,
the operation body further includes a release-holding part with which the another end of the stopper is engaged so as to hold the operating body at the released position is provided in the cam groove located in a rear portion of the lock cam part,
the restriction part restricts the operating body to move in the forward direction to provide a gap with a predetermined interval between the operating body and the restriction part in the forward direction and the rearward direction when the operating body is located at the released position.

2. The push switch according to claim 1, further comprising a stopper guide extending rearward from the cam groove near the release-holding part, wherein the stopper guide has a step part provided at a boundary between the stopper guide and the cam groove, the step part being higher than the cam groove in a direction toward the upper surface of the operating body.

3. The push switch according to claim 2, wherein the stopper guide having substantially s grooved shape extending rearward and tilted oblique with respect to the forward direction and the rearward direction.

4. The push switch according to claim 1, further comprising a cover for covering the opening of the case, wherein the one end of the stopper is engaged with the cover to be fixed to the cover.
